(19) United States
(12) Patent Application Publication
(10) Pub. No.: US 2010/0006038 A1
(43) Pub. Date: Jan. 14, 2010

(54) Walking function recovery device for pet

(76) Inventor: Hidetaka Matui, Fukuoka (JP)

Correspondence Address: JORDAN AND HAMBURG LLP, 122 EAST 42ND STREET, SUITE 4000, NEW YORK, NY, 10168, US

(21) Appl. No.: 12/284,067

(22) Filed: Sep. 18, 2008

(30) Foreign Application Priority Data
Jul. 8, 2008 (JP) 2008-177970

(51) Int. Cl. A01K 15/02

(52) U.S. Cl. 119/725

(57) ABSTRACT

A walking-function recovery device for a pet provided with: a rotating arm unit that is arranged on a base and is rotatably around the base in a circumferential direction; a lifting wire that is suspended from a distal end of the rotating arm unit and acts on a pet via a constant-load spring a lifting force of a predetermined magnitude; and a suspension that is connected to a distal end of the lifting wire and is hooked and supported by two points on front-leg and rear-leg sides of a pet torso.

### BACKGROUND OF THE INVENTION

The present invention relates to a walking aid for a pet. More particularly, the present invention relates to a walking-function recovery device for a pet, suitable for obesity prevention or walking rehabilitation of a quadruped such as a dog.

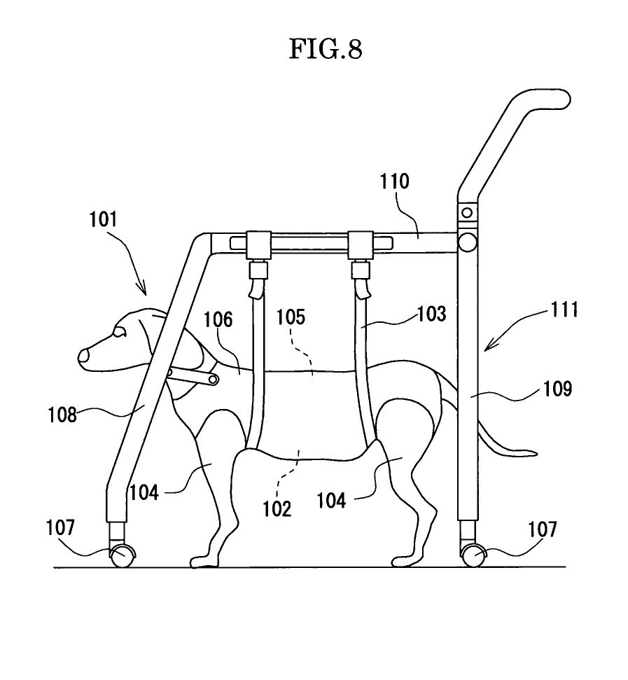

There has been conventionally proposed a walking aid for a pet, intended to prevent excessive obesity or to be used for walking rehabilitation after a leg or legs of a dog have been broken. Such a proposal is described in Japanese Published Unexamined Patent Application No. 2003-9704 (hereinafter, referred to as Patent Document 1), for example. More specifically, as shown in FIG. 8, there is proposed a walking aid for a pet configured so as to include: band-shaped straps 103 extended upwardly from a position of an abdomen 102 of a pet 101; a suspension support 106 for wrapping around a torso 105 in a manner to expose legs 104 of the pet 101; an upper portion of a front leg 108 of which the bottom is provided with a wheel 107 and that of a rear leg 109 being connected by a support rod 110; and a travel cart 111 for suspending the suspension support 106 by the support rod 110.

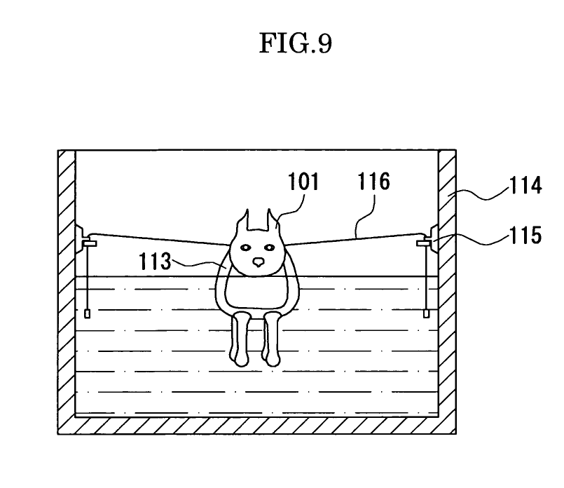

An exercise aid for an animal is described in Japanese Published Unexamined Patent Application No. 2004-81072 (hereinafter, referred to as Patent Document 2), for example. More specifically, as shown in FIG. 9, there is described an exercise aid for an animal configured so as to include: a jacket 113 secured around a torso of the pet 101 and having front-leg insertion holes; and mooring ropes 116 of which one end is locked to the jacket 113 and of which the other end is provided with fixing means 115 for mooring the jacket 113 to an edge, etc., of a bathtub 114.

The walking aid for a pet in Patent Document 1 is that which alleviates a burden applied to legs and hips by suspending the pet with the suspension support so as to ease walking. However, the torso of the pet is pressed by the suspension support all the time, and further, the pet is in a state of being enclosed by frames of the travel cart, which instills fear in the dog. Thus, it is probably impractical to involuntarily force the pet to walk.

This aid is configured so that the travel cart is pushed by a dog owner, et. al., matching the walking of the dog. However, when pushed too hard, for example, the dog is forced to involuntarily walk, and when pushed too weakly, the dog is burdened by the travel cart, which in turn applies a stress to the dog.

In the exercise aid for an animal in Patent Document 2, a load applied to an entire body in water is alleviated due to a force of buoyancy. However, the dog is in a state of being suspended in water while being moored to the edge, etc., of a bathtub by jacket, and as a result, the dog can only exercise by moving his legs in water, and the dog is probably in a state of panic resulting from restriction caused by the jacket and fear of water.

There is a walking training in which a water current is generated in a water tank, or a dog is walked in a dedicated swimming pool. However, there arises a problem that in such a walking training, the water tank and accessory facilities become huge.

### SUMMARY OF THE INVENTION

The present invention has been achieved in view of the aforementioned circumstances, and an object thereof is to provide a walking-function recovery device for a pet, capable of performing a walking exercise in parallel with a pet while alleviating a load applied to the front legs and rear legs of the pet.

To achieve the above-described object, a walking-function recovery device for a pet according to the present invention is provided with: a rotating arm unit that is arranged on a base and is rotatably around the base in a circumferential direction; a lifting wire that is suspended from a distal end of the rotating arm unit and acts on a pet via a balancer with a lifting force of a predetermined magnitude; and a holding unit provided at the distal end of the rotating arm unit.

Herein, resulting from the lifting force of the balancer, the gravitational force of a pet itself is alleviated, and thus, the pet becomes able to walk, and in addition, the pet becomes able to perform a walking exercise in a limited space such as inside a room without anxiety by a pet owner walking together with the pet while holding the holding unit of the distal end of the rotating arm unit.

When an alternate end of the lifting wire of which one end is connected to the balancer is anchored with a suspension hooked and supported by two points on the front-leg and rear-leg sides of a pet torso, it becomes possible to appropriately distribute the lifting force to the front legs and the rear legs of the pet.

When the rotating arm unit is connected and pivotally supported to a mast unit provided upright in a state rotatable on the base and an angle-adjusting support unit extends across the rotating arm unit and the mast unit, it becomes possible to adjust a height of the holding unit at the distal end of the rotating arm unit to a position of a hand of a pet owner, and also to perform a height adjustment of the rotating arm unit according to a size of the pet.

The balancer is configured by an air tank and an air cylinder attached to the mast unit and the wire is connected to a rolling-up unit with a ratchet, attached to a rod of the air cylinder. As a result, it becomes possible to cancel the rolling up of the wire by the ratchet at the time of attaching the suspension to the pet and actuate a lifting force of a predetermined magnitude by an air pressure injected into the air cylinder by rolling up the wire after adjusting the lifting of the pet.

The rotating arm unit is rendered telescopic, and thereby, it becomes possible to freely adjust a circumferential radius according to types or sizes of the pet.

According to the walking-function recovery device for a pet of the present invention, the gravitational force of the pet itself is alleviated by the lifting force-of the balancer, and thus, the pet becomes able to walk by a strength smaller than a normal leg strength, which results in exhibiting an excellent effect in a rehabilitation after a surgical operation in an animal hospital or an exercise for a pet that finds it difficult to walk resulting from weakened legs and hips.

When the suspending force is distributed by the suspension to the front legs and the rear legs of the pet, the pet becomes able to walk in a state close to a natural setting.

### BRIEF DESCRIPTION OF PREFERRED EMBODIMENTS

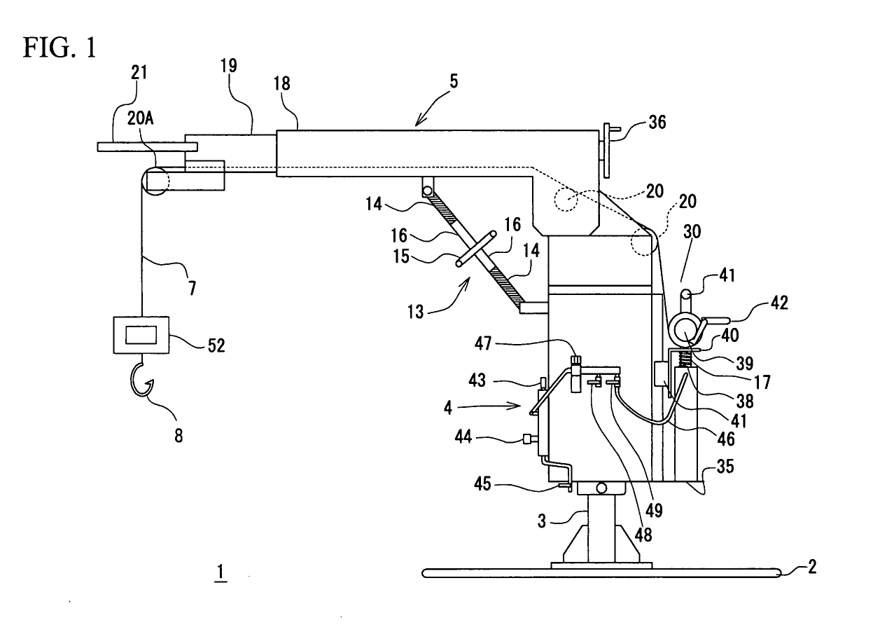

FIG. 1 is a side view showing one example of a walking-function recovery device for a pet to which the present invention is applied;

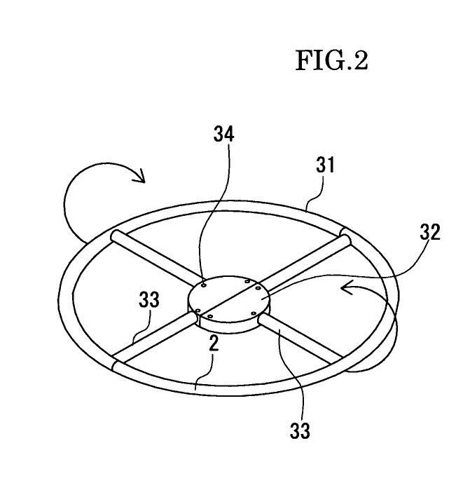

FIG. 2 is a perspective view showing one example of a base of the walking-function recovery device for a pet to which the present invention is applied;

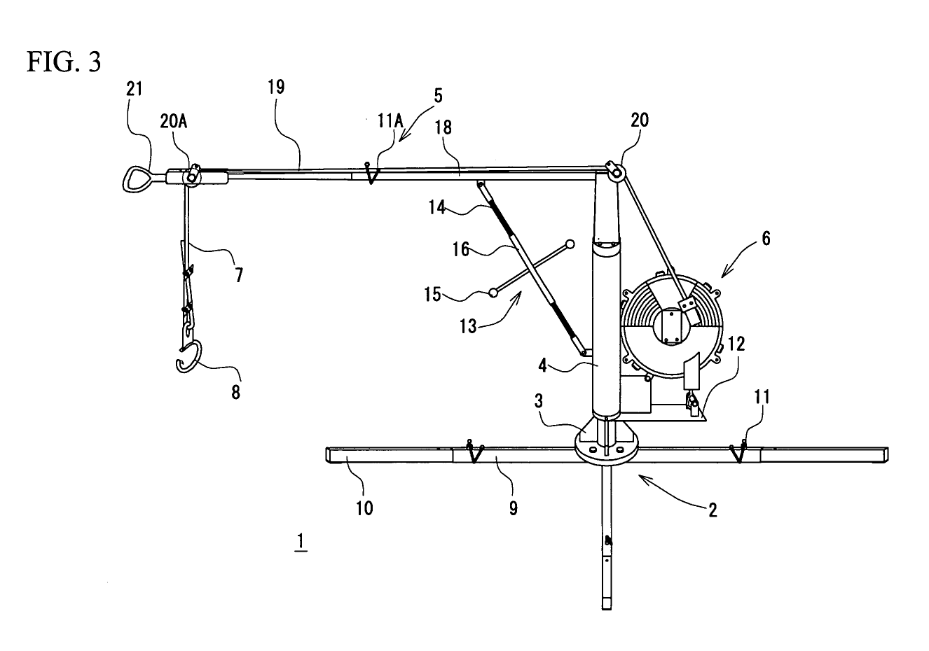

FIG. 3 is a perspective view showing another example of a walking-function recovery device for a pet to which the present invention is applied;

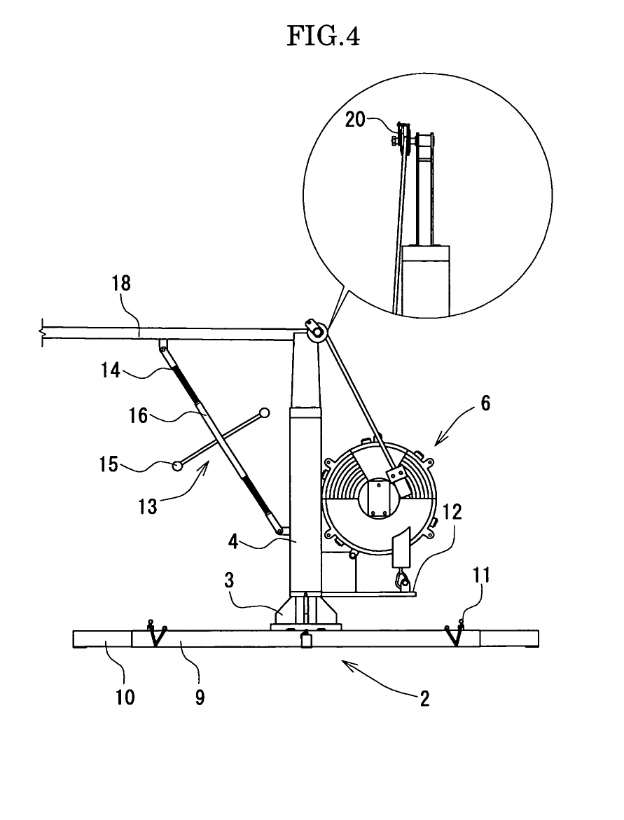

FIG. 4 is an explanatory diagram showing another example of a post unit of the walking-function recovery device for a pet to which the present invention is applied;

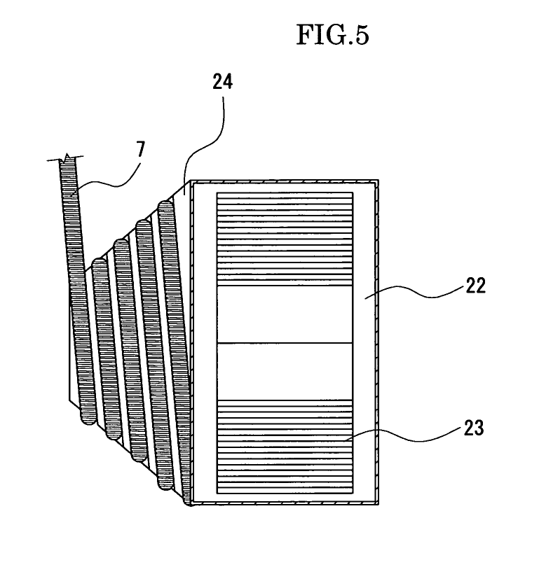

FIG. 5 is an explanatory diagram showing one example of a constant-load spring of the walking-function recovery device for a pet to which the present invention is applied;

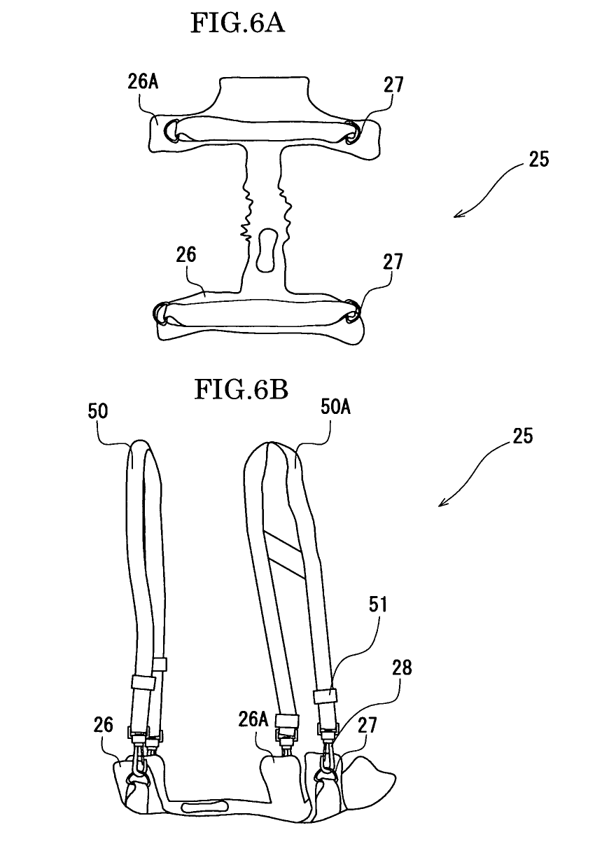

FIG. 6 is an explanatory diagram showing one example of a suspension of the walking-function recovery device for a pet to which the present invention is applied;

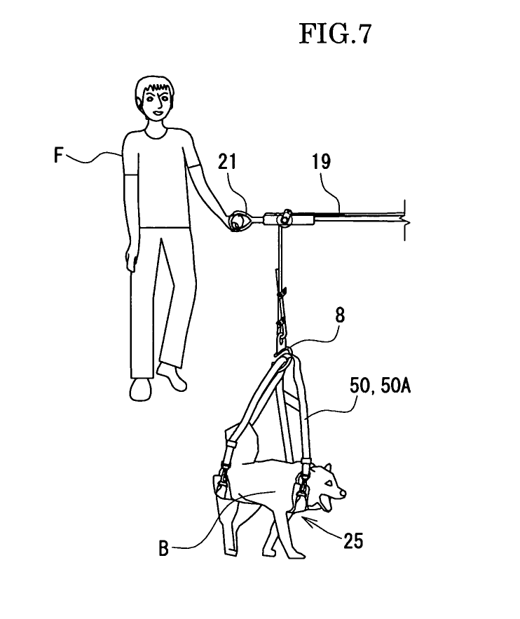

FIG. 7 is an explanatory diagram showing one example of a state in which the walking-function recovery device for a pet to which the present invention is applied is used;

FIG. 8 is an explanatory diagram showing one example of a conventional walking aid for a pet; and

FIG. 9 is an explanatory diagram showing one example of a conventional exercise aid for an animal.

### DETAILED DESCRIPTION OF PREFERRED EMBODIMENTS

FIG. 1 is a side view showing one example of a walking-function recovery device for a pet to which the present invention is applied, and FIG. 2 is an explanatory diagram showing one example of a base of the walking-function recovery device for a pet to which the present invention is applied.

A walking-function recovery device for a pet 1 shown here is configured by: a mast support unit 3 arranged at a center of a base 2; a mast unit 4 provided upright in a state rotatable about the mast support unit 3; a rotating arm unit 5 of which the proximal end is connected and pivotally supported at an upper end of the mast unit 4; and a lifting wire 7 connected from a distal end side of the rotating arm unit 5 to an air cylinder unit 30, as a balancer, attached to the mast unit 4.

In the base 2, an annular pipe 31 that can be freely divided, and a mast-support-unit fixing unit 32 having screw holes 34 opened, the screw holes 34 being for screwing and fixing the mast support unit 3 at a center of the annular pipe 31 by a fastening screw 29 such as a bolt, are arranged by support pipes 33.

The mast support unit 3 attached to the mast-support-unit fixing unit 32 is rotatably mated with the mast unit 4 via a bearing (not shown). At a lower portion of the mast unit 4, a table for mounting an air cylinder 35 is protruded in a horizontal direction, and at an upper end of the mast unit 4, a pulley 20 is further attached.

Between the rotating arm unit 5 connected and pivotally supported at the upper end of the mast unit 4 and the mast unit 4, an angle-adjusting support unit 13 is connected and pivotally supported. The angle-adjusting support unit 13 is configured so that connection screw pipes 16 formed by attaching a handle to connecting screw rods 14 on the sides of the rotating arm unit 5 and the mast unit 4 are attached by screwing, and when the connection screw pipes 16 are rotated by the handle in the left and right directions, a stroke of the angle-adjusting support unit 13 is extended or contracted thereby to freely adjust an angle of elevation of the rotating arm unit 5.

The rotation arm unit 5 is configured by: a base arm unit and an accommodated arm unit 19 that is accommodated in the base arm unit 18 in a state to be freely ejected therefrom or retracted thereinto, and is configured to be capable of freely ejecting or retracting the accommodated arm unit 19 on extending/contracting handle 36 provided at a proximal end of the base arm unit 18.

At a distal end of the accommodated arm unit 19, a pulley 20A is provided and an annular holding unit 21 that can be held by hand is attached. When a pet owner walks around the base 2 while gripping the holding unit 21, it becomes possible to perform a walking exercise together with the pet.

On the air-cylinder-mounting table 35, the air cylinder unit 30 is mounted. At an upper end of a piston rod 38 of the air cylinder unit 30, a rolling-up-drum receiving plate 40 is attached, and by an up-and-down slide unit 41 provided between the side surface of the mast unit 4 and the piston rod 38, the rolling-up-drum receiving plate 40 is able to perform a stable up-and-down movement.

On the rolling-up-drum receiving plate 40, a wire drum 39 is attached. A proximal end of the lifting wire 7 is connected and wound around the wire drum 39, and a distal end side of the lifting wire 7 is dropped from a distal end of the accommodated arm unit 19 through a pulley 20 of the mast unit 4 and the pulley 20A of the accommodated arm unit 19. A distal end of the lifting wire 7 is attached with a hook 8.

Herein, at the wire drum 39, a rolling-up handle 41 and a ratchet 42 are provided. When the lifting wire 7 wound around by the wire drum 39 is sent forth by the ratchet 42, if the ratchet 42 is canceled, the lifting wire 7 is brought down. As a result, it becomes easy to attach the lifting wire 7 to the pet.

A coil spring 17 is outwardly inserted to the piston rod of the air cylinder unit 30. When a total weight by the wire drum 39 provided on the rolling-up-drum receiving plate and the wire 7 is received by the coil spring 17, a load applied to the piston rod 38 is offset.

Therefore, an adjustment of the balancer by the air cylinder unit 30 results in an adjustment that matches the weight of the pet only, and thus, an adjustment by an air pressure becomes easy and a capacity or an air pressure of an air tank can be minimized.

The air tank 37 installed inside the mast unit 4 is provided with: a pressure meter 43 indicating a pressure inside the air tank; a one-touch coupler 44 for injecting an air pressure inside the air tank 37 from the outside; and a drain cock 45 for extracting the air pressure inside the air tank 37 and discharging water remaining inside the air tank 37. Further, between the air tank 37 and the air cylinder unit 30, an air hose 46 for injecting air to the inside of the air cylinder unit 30 is provided.

In the air hose 46 provided between the air tank 37 and the air cylinder unit 30, there exist: a regulator 47 for regulating a pressure in a lifting direction by regulating the air pressure injected to the inside of the air cylinder unit 30; a valve for discharging an air pressure inside a cylinder 48 for arbitrarily moving the hook 8 by causing the air pressure inside the air cylinder unit 30 to be discharged; and a cylinder-pressure holding valve 49 for preventing the air pressure from escaping from the regulator 47 resulting from a change in pressure due to the up-and-down movement of the piston rod 38 after regulating the air pressure.

The hook 8 is attached to the distal end of the lifting wire 7 via a load cell-type suspending balance 52. The load cell-type suspending balance 52 is provided with a function of displaying a suspended load. For example, when a dog weighing 10 kg is suspended and 5 kg is displayed, this means that the weight is decreased to half. When 10 kg is displayed, this means that nearly the entire weight is decreased.

Therefore, when the load cell-type suspending balance 52 is provided to freely adjust the air pressure injected to the inside of the air cylinder unit 30, it becomes possible to freely adjust a decrease in the weight of a large-sized dog, a medium-sized dog, or a small-sized dog, for example, which enables a running exercise according to the condition of leg strength of the dog.

FIG. 3 is a perspective view showing another example of a walking-function recovery device for a pet to which the present invention is applied, and FIG. 4 is an explanatory diagram showing another example of a post unit of a walking-function recovery device tool for a pet to which the present invention is applied.

The walking-function recovery device for a pet 1 shown here is configured by: the mast support unit 3 arranged at a center of the base 2; the mast unit 4 provided upright in a state rotatable about the mast support unit 3; the rotating arm unit 5 of which the proximal end is connected and pivotally supported at an upper end of the mast unit 4; and a suspension 8 suspended by the lifting wire 7 wound around a constant-load spring 6, serving as a balancer, attached to the mast unit 4 from the distal end side of the rotating arm unit 5.

The base 2 is configured by four legs 9 and accommodated legs 10 into and from which the respective legs 9 are ejected and retracted freely. This mechanism is such that upon assembly, the accommodated legs 10, which are pulled out from the legs 9, are screwed and fixed by fixing screws 11.

The mast unit 4 is rotatably mated with the mast support unit 3 attached to the center of the base 2 via a bearing (not shown). At the lower portion of the mast unit 4, a table for mounting a constant-load spring 12 is protruded in a horizontal direction, and at an upper end of the mast unit 4, the pulley 20 is further attached.

Between the rotating arm unit 5 connected and pivotally supported at the upper end of the mast unit 5 and the mast unit 4, the angle-adjusting support unit 13 is connected and pivotally supported. The angle-adjusting support unit 13 is configured so that the connection screw pipes 16 formed by attaching a handle 15 to connecting screw rods 14 on the sides of the rotating arm unit 5 and the mast unit 4 are attached by screwing, and when the connection screw pipes 16 are rotated by the handle 15 in the left and right directions, a stroke of the angle-adjusting support unit 13 is extended or contracted thereby to freely adjust the angle of elevation of the rotating arm unit 5.

The rotating arm unit 5 is configured by: the base arm unit 18; and the accommodated arm unit 19 that is freely ejected from the base arm unit 18 and retracted thereinto. Its mechanism is such that upon assembly, the accommodated arm unit 19 is pulled out from the base arm unit 18, and is screwed and fixed by a fixing screw 11A.

At the distal end of the accommodated arm unit 19, the pulley 20A is provided and the annular holding unit 21 that can be held by hand is attached. When the pet owner walks around the base 2 while gripping the holding unit 21, it becomes possible to perform a walking exercise together with the pet.

The constant-load spring 6 is a device for causing a lifting force of a constant load to be actuated all the time, and as shown in FIG. 5, the coil spring 23 is wound around the drum 22 and the lifting wire 7 is connected and wound around an axial center 24 of the drum 22.

The table for mounting a constant-load spring 12 is connected and fixed with the constant-load spring 6, and the lifting wire 7 is dropped from the distal end side of the accommodated arm unit 19 through the pulley 20 of the mast unit 4 and the pulley 20A of the accommodated arm unit 19 and the hook 8 is attached at the distal end of the lifting wire 7.

Subsequently, as shown in FIG. 6, to the air cylinder described in detail or the hook 8 in the walking aid for a pet by the constant-load spring, a suspension 25 for lifting the pet is anchored.

In the suspension 25, on both-side ends of belt units 26 and 26A secured in a manner to wrap around an abdomen side of a torso on the front-leg and rear-leg sides of the pet such as a dog, connecting rings 27 are each attached.

To the connecting rings 27 of the belt unit 26 on the front-leg side and the belt unit 26A on the rear-leg side, lifting bands 50 and 50A attached with detachable connecting hooks 28 are connected, and lengths of the lifting bands 50 and 50A can be freely adjusted by length-adjusting buckles 51.

In the thus configured walking-function recovery device for a pet of the present invention, as shown in FIG. 7, the belt units 26 and 26A of the suspension 25 are attached to be secured around the torso of a dog A on the front-leg and rear-leg sides, and thereafter, the lifting bands 50 and 50A are connected.

Subsequently, the ratchet 42 engaged with the wire drum 39 in FIG. 1 is removed, the lifting wire 7 wound around by the wire drum 39 is brought down, the hook 8 at the distal end of the lifting wire 7 is anchored to the lifting bands 50 and 50A of the suspension 25, and the ratchet 42 is engaged with the wire drum 39. Thereafter, the lifting wire 7 is rolled up by the rolling-up handle 41, thereby lifting the suspension 25.

In this case, in order to adjust a distribution of the lifting force actuated on the front legs and the rear legs of the dog A by the air cylinder or the balancer by the constant-load spring, a length adjustment is performed by the lifting bands 50 and 50A provided in the belt units 26 and 26A. As a result, it becomes easy to adjust a distributing force of the lifting force actuated on the front legs and the rear legs of the dog A.

When an adjustment is performed so that the lifting force of the balancer by the air cylinder or the constant-load spring is ½ the weight of the dog according to the weight of the dog, for example, ½ of a gravitational force actuated on the legs of the dog A is offset. Therefore, the loads applied to the front legs and the rear legs are reduced to half, and thus, it becomes possible to alleviate a burden resulting from walking.

Further, when a dog owner F, et al., grips the holding unit 21 attached to the distal end side of the arm unit 5, the dog owner F is in a state of standing alongside the dog A. As a result, the dog owner F is able to walk around the base 2 in an environment where the dog owner F can walk with the dog A.

In this way, the dog A is able to perform the walking exercise together with the dog owner F, it becomes possible to walk around while observing the walking state of the dog A. Further, the front-leg and rear-leg sides of the dog A are lifted and the forces applied to the front legs and the rear legs are distributed, and in this state, the gravitational force is offset. Thereby, the dog A does not have discomfort and it becomes possible to walk in a state that the burdens applied to the front legs and the rear legs are alleviated.

A constant-load spring of which the lifting force is about 10 kg for a small-sized and medium-sized dog and that is about 30 kg for a large-sized dog are prepared, and the constant-load springs can be switched depending on the size of the dog. In addition, when the length of the rotating arm unit is adjusted, a circumferential radius can be adjusted.

What is claimed is:

1. A walking-function recovery device for a pet, including
a rotating arm unit that is arranged on a base and is rotatably around the base in a circumferential direction;
a lifting wire that is suspended from a distal end of the rotating arm unit and acts on a pet via a balancer with a lifting force of a predetermined magnitude; and
a holding unit provided at the distal end of the rotating arm unit.

2. The walking-function recovery device for a pet according to claim 1,
wherein an alternate end of the lifting wire of which one end is connected to the balancer is anchored with a suspension hooked and supported by two points on the front-leg and rear-leg sides of a pet torso.

3. The walking-function recovery device for a pet according to Claim 1, wherein
the rotating arm unit is connected and pivotally supported to a mast unit provided upright in a state rotatable on the base, and an angle-adjusting support unit extends across the rotating arm unit and the mast unit.

4. The walking-function recovery device for a pet according to claim 3, wherein
the balancer is configured by an air tank and an air cylinder attached to the mast unit, and the wire is connected to a rolling-up unit with a ratchet, attached to a rod of the air cylinder.

5. The walking-function recovery device for a pet according to claim 1, wherein
the rotating arm unit is telescopic.
